(19) United States
(12) Patent Application Publication
(10) Pub. No.: US 2016/0215136 A1
(43) Pub. Date: Jul. 28, 2016

(54) ABRASION-RESISTANT MATERIALS

(71) Applicant: BRNO UNIVERSITY OF TECHNOLOGY, Brno (CZ)

(72) Inventors: Josef Jancar, Brno - Kohoutovice (CZ); Radka Balkova, Brno - Medlanky (CZ); Petr Polacek, Slapanice (CZ); Frantisek Kucera, Brno - Husovice (CZ)

(73) Assignee: BRNO UNIVERSITY OF TECHNOLOGY, Brno (CZ)

(21) Appl. No.: 14/917,522

(22) PCT Filed: Sep. 30, 2014
(86) PCT No.: PCT/CZ2014/000106

§ 371 Date: Mar. 8, 2016

(30) Foreign Application Priority Data
Sep. 30, 2013 (CZ) PV 2013-758
Sep. 30, 2013 (CZ) PV 2013-759

(51) Int. Cl. C08L 33/14

(52) U.S. Cl. CPC C08L 33/14

(57) ABSTRACT

An abrasion resistant material includes a polymeric matrix composite, preferably an amorphous thermoplastic or a resin containing homogenously dispersed nanoparticles ranging in size from 1 to 50 nm, further combined with clusters of the nanoparticles, or a combination of nanoparticles of different sizes within the above-stated range. A method of preparation of, and automotive parts containing, this material are also disclosed.

### FIELD OF ART

The present invention relates to materials, in particular thermoplastic nanostructured materials, suitable for exterior and interior automotive parts or nanocomposite resins, showing an increased abrasion resistance (resistance against wear and scratching). Furthermore, the invention relates to methods of preparation of the said materials.

### BACKGROUND ART

Plastics used in the automobile industry for self-supporting exterior and interior parts in executive automobiles include mainly polymethylmethacrylate (PMMA) and polycarbonate (PC) in high-gloss black. During washing or upon contact with such abrasive objects as keys or fingernails, scratching of surfaces may occur, reducing sheen and negatively affecting the overall appearance of the car or interior. Long term abrasion resistance of such plastic parts, whilst maintaining weight, aesthetic appearance and processing technology, is a demand of automobile manufacturers.

Polymeric nanocomposites have been developed that improve certain properties of the plastics; ordinarily however, it comes at the expense of degrading other characteristics. There are many aspects to why a material is susceptible to scratching or why it is not, and most tests are not capable of uncovering all of them. How nicks and scratches occur in plastic is a complex subject and depends upon the abrasion resistance of the material as well as on how conspicuous the potential blemishes are.

Resins used in the various engineering and construction applications are similarly lacking in abrasion resistance, leading to substratal surface exposure and thus to irregular wear and potentially localized corrosion. Long term abrasion resistance, whilst maintaining aesthetic appearance and process technology, is a demand of flooring manufacturers and producers of paints and resins for wood and metal, among other branches of industry.

### DISCLOSURE OF THE INVENTION

The present invention provides an abrasion resistant material comprising a polymeric matrix composite, preferably selected from the group comprising amorphous thermoplastics and chemically, thermally or by radiation crosslinkable resins, containing homogenously dispersed nanoparticles ranging in size from 1 to 50 nm, more preferably from 2 to 50 nm, preferably from 1 to 20 nm, more preferably 2 to 20 nm, further combined with clusters of the said nanoparticles, or a combination of nanoparticles of different sizes within the above stated range. The nanoparticles can be of various shapes and can have various surface modification. Clusters include also aggregates and agglomerates.

When the polymeric matrix is amorphous thermoplastic, nanoparticles having the size in the range of 1 to 50 nm are then preferably dispersed in a quantity of 0.1 to 15 vol. % relative to the volume of the amorphous thermoplastic.

When the polymeric matrix is resin, nanoparticles having the size in the range of 2 to 50 nm are preferably dispersed in a quantity of up to 6 vol. % relative to the volume of the resin.

Preferably, the amorphous thermoplastic is selected from the group comprising polyesters such as polymethylmethacrylate (PMMA), methacrylate and acrylate copolymers, polyethylene terephthalate (PET) and polycarbonate (PC), or amorphous polymers such as polystyrene (PS).

In another preferred embodiment, the resins may include dimethacrylate, epoxy resin, polyurethane or polyurethane/acrylic resins that harden after application by chemical, thermal or radiation crosslinking, polymeric dispersions hardening by the evaporation of solvents, or fusible resin powders that are spread on a surface and then exposed to high temperatures to induce a process of melting and sintering into a compact layer.

The abrasion resistant material is thus, depending upon the starting polymeric matrix, preferably selected from the group comprising thermoplastic material and nanocomposite resin.

Preferably, the nanoparticles are selected from pyrolytic silica, colloidal silica, POSS particles (polyhedral silsesquioxane), laponite, montmorrilonite, alumina, Al₂O₃ whiskers, cellulose whiskers and nanocrystals, ZrO₂ particles, graphene, C60, carbon nanotubes or a combination of the said particles. Preferably, the surface of the nanoparticles is modified by an oligomer that is compatible with the polymeric matrix—e.g., amorphous thermoplastic or resin—in which they are dispersed. Herein, oligomeric compatibility means a physicochemical similarity between the oligomer and the polymeric matrix. For instance, it can denote an oligomer of identical monomeric units to those of the matrix, or an oligomer of functionalized monomers of the matrix.

Preferably, the different sizes of the nanoparticles are such that one group of nanoparticles are at least 2× larger, preferably 5× larger, than the other group of nanoparticles. Both groups may be either of the same material or of different materials.

More preferably, the nanoparticles are pyrolytic silica, in particular surface modified by methacryl silane. Pyrolytic silica is prepared via hydrolysis of SiCl₄ vapor in an oxy-hydrogen flame. Initial hydrolysis produces spherical particles of silica having the diameter from 7 to 14 nm. These particles, upon exposure to high temperatures, coagulate and coalesce and after cooling, collide to form aggregates possessing an average dimension of approximately 100 nm. Pyrolytic silica is characteristic by the nature of its surface, which is dominated by Si—O—Si units. The production process leads to smooth surface particles, enabling non-covalent interactions like hydrogen bonding or Van der Waals interactions. Primarily in moist environments, Si—O bonds may be hydrogenated into silanol groups that, in turn, lead to the hydrophilic nature of the surface.

The present invention further provides a method of preparation of the abrasion-resistant material, e.g. nanocomposite resin or thermoplastic material, wherein monomers (of, e.g., amorphous thermoplastic or resin) are mixed with nanoparticles and optionally other components, and the mixture is stirred for at least 1 hour and subsequently subjected to sonication for at least 0.5 hour.

More specifically, the invention provides a method of preparation for a UV curable resin, wherein a polyurethane acrylate monomer is mixed with a UV polymerization initiator and, nanoparticles, and the mixture is stirred for at least 1 hour and subsequently subjected to sonication for at least 0.5 hour. The UV polymerization initiator is preferably a mixture of camphoroquinone ((1S)-2,3-Bornandion) and 2-(N,N-dimethylamino)ethyl methacrylate (DMAEMA) in a quantity of up to 2 wt. % relative to the weight of the reaction mixture.

A method was developed, applicable to PMMA, PC and other amorphous thermoplastics as well as to resins, allowing the uniform dispersion of nanoparticles with a dimension of 2 to 50 nm, achieving control over attractive interactions between the surface of the nanoparticles and the polymer chains, so as to achieve an increase in surface hardness, reduce the friction coefficient and increase rigidity and yield stress without significantly reducing ductility. This combination of qualities is what determines the emergence and visibility of abrasive marks. In this regard, an improvement in abrasion-resistance and a reduction in the visibility of potential blemishes was achieved.

Nanocomposite materials of the invention, primarily resins, demonstrate excellent abrasion-resistance. An entirely unique characteristic exhibited by these nanocomposite resins is minimal surface wettability, significantly expediting and simplifying maintenance of surfaces coated with such modified elements and may even result in a self-cleaning effect. The addition of a nanofiller led to considerable changes in the properties of the cured resin. An increase in the modulus of elasticity by 150% and in strength by 90% was achieved. The material remained transparent while its viscosity increased only slightly. The newly modified resin meets manufacturers requirements for abrasion-resistance in such fields as flooring and protective wood and metal coatings, among other branches of industry, whilst maintaining aesthetic appearance and production technology without causing a substantial increase in overall price. It may also be utilized in many other fields: the automobile industry, engineering, construction etc.

In accordance with the invention, for preparation of automotive parts from nanocomposite material, PMMA and PC nanoparticles may be modified during manufacturing, or plastic parts may laminated or injected with a layer of nanoparticle-modified PMMA or PC. The latter option provides possibilities of color or design modifications.

### EXAMPLES OF CARRYING OUT THE INVENTION

### Example 1

The reaction mixture was prepared by dissolving the following initiators: 0.3 wt. % camphorquinone and 0.2 wt. % DMAEMA in a polyurethane-acrylate monomer, while stirring for 30 mins. at room temperature. The process was conducted in the absence of light to prevent premature polymerization.

Unmodified (Aerosil 200) or surface modified by methacryl silane (Aerosil R711) pyrolytic silica nanoparticles were subsequently dried in a vacuum for 1 hour at a temperature of 120° C. and then added to the mixture, and dispersed using one of the following procedures:

1) Nanoparticles were stirred into the mixtures at laboratory temperature for 3 hours.

2) Nanoparticles were stirred into the mixtures at laboratory temperature for 3 hours and subsequently exposed to an ultrasonic bath (K5, Kraintek) at 30° C.

The mixtures were then poured into rubber molds and cured using UV radiation.

Table 1 shows the physicochemical data of Aerosil 200 and Aerosil R711.

Table 2 shows the percentage of silica in the composites.

TABLE 1

| | | AEROSIL ® | AEROSIL ® |
|---|---|---|---|
| | | 200 | R711 |
| Type of silica | | Typical | Typical |
| Characteristic | Unit | value | value |
| Specific surface area (BET) | m²/g | 200 ± 25 | 150 ± 25 |
| Average primary particle size | nm | 12 | 14 |
| Carbon content | wt. % | 4.5-6.5 | 4.5-6.5 |
| Tap density | g/l | Approx. 50 | Approx. 60 |
| in accordance with | | | |
| DIN EN ISO 787/11 | | | |
| Humidity | wt. % | ≦1.5 | ≦1.5 |
| 2 hours at 105° C. | | | |
| Loss on ignition, 2 hours at 1000° C., | wt. % | ≦1.0 | 6.0-11.0 |
| Determined for materials dried 2 | | | |
| hours at 105° C. | | | |
| pH of 4% dispersion | | 3.7-4.7 | 4.0-6.0 |
| SiO2 content | wt % | ≦99.8 | ≦99.8 |
| in the annealed material | | | |

TABLE 2

| | Pure | 0.5US | 1US | 2US | | | |
|---|---|---|---|---|---|---|---|
| Sample | PUA | (0.5TS) | (1TS) | (2TS) | 3US (3TS) | 4US (4TS) | 6TS |
| wt. % | 0 | 0.5 | 1 | 2 | 3 | 4 | 6 |
| vol. % | 0 | 0.3 | 0.5 | 1.1 | 1.6 | 2.2 | 3.3 |

US . . . Aerosil 200;
TS . . . Aerosil R711

Tensile strength was measured on a Zwick testing machine (Zwick-Roell, model Z010/TH2a) with a weight of 500 N at room temperature and a head speed of 50 mm/min. Samples for this test were dog-bone-shaped. Young's modulus, tensile strength and elongation were calculated automatically by computer. Presented is the average of at least 5 measurements for each sample, the experimentwise error rate is ±10%. The results are presented in tables 3 and 4.

TABLE 3

| Silica | PUA with US | | | PUA with TS | | |
|---|---|---|---|---|---|---|
| con- | | Young's | Tensile | | Young's | Tensile |
| tent | Method of | modulus | strength | Method of | modulus | strength |
| wt. % | dispersion | (MPa) | (MPa) | dispersion | (MPa) | (MPa) |
| 0 | — | 117.5 | 11.7 | — | 117.5 | 11.7 |
| 3 | 1 | 390.4 | 14.8 | 1 | 423.4 | 15.9 |
| 3 | 2 | 572.7 | 15.6 | 2 | 632.2 | 18.1 |

From the results it is evident that uniform dispersion, achieved by utilizing procedure 2, significantly improves the characteristics of lacquer strength and durability.

TABLE 4

| | PUA with US | | | PUA with TS | | |
|---|---|---|---|---|---|---|
| | | | Elongation | | | Elonga- |
| Silica | Young's | Tensile | at | Young's | Tensile | tion at |
| content | modulus | strength | break | modulus | strength | break |
| wt. % | (MPa) | (MPa) | (%) | (MPa) | (MPa) | (%) |
| 0 | 117.5 | 11.7 | 21.6 | 117.5 | 11.7 | 21.6 |
| 0.5 | 150.6 | 13.9 | 21.4 | 172.6 | 15.2 | 21.5 |
| 1 | 204.9 | 14.3 | 19.7 | 217.5 | 16.3 | 20.0 |
| 2 | 433.3 | 14.6 | 7.0 | 470.3 | 17.0 | 9.2 |
| 3 | 572.7 | 15.6 | 5.9 | 632.2 | 18.1 | 5.3 |
| 4 | 502.9 | 13.4 | 3.7 | 551.3 | 16.9 | 5.2 |
| 6 | — | — | — | 487.8 | 16.4 | 5.9 |

### Example 2

Polymeric nanocomposite based on PMMA (Plexiglas Formmase Transparent 8N) or PC (Makrolon) with a volume fraction of silica nanoparticles (silica—unmodified surface Sigma-Aldrich—specific surface area 390 m²/g , particle size 7 nm; silica coated with Cab-O-Sil TS-530—surface area 220 m²/g) 2, 4, 8 and 12 vol % was prepared utilizing the following procedure:

1) Thermoplastic granulate was dried at 90° C.

2) The granulate was then dissolved in various organic solvents (acetone, toluene, acetone/toluene 1:1, dichloromethane, methyl ethyl ketone).

3) Nanoparticles were vacuum-dried at 120° C. for 24 hours.

4) The nanoparticles were subsequently dispersed through sonication and stirred into the same solvent at 50° C. for 1 hour.

5) The mixture of nanoparticles and solvent were added to the dissolved granulate and stirred for 3 hours.

6) The organic solvent was removed through gradual drying at stirring by a mechanical stirrer. Subsequently the dried thermoplastic nanocomposite was crushed (drying at 140° C. for 2 hours, grinding, drying at 145 C for 3 hours, crushing, vacuum drying at 150° C. for 3 hours).

7) The dried thermoplastic nanocomposite was pressed at 190 ° C. into sheets 0.5 mm thick.

| | | AEROSIL ® | AEROSIL ® |
|---|---|---|---|
| | | 200 | R711 |
| Type of silica | | Typical | Typical |
| Characteristic | Unit | value | value |
| Specific surface area (BET) | m²/g | 200 ± 25 | 150 ± 25 |
| Average primary particle size | nm | 12 | 14 |
| Carbon content | wt. % | 4.5-6.5 | 4.5-6.5 |
| Tap density | g/l | Approx. 50 | Approx. 60 |
| in accordance with | | | |
| DIN EN ISO 787/11 | | | |
| Humidity | wt. % | ≦1.5 | ≦1.5 |
| 2 hours at 105° C. | | | |
| Loss on ignition, 2 hours at 1000° C., | wt. % | ≦1.0 | 6.0-11.0 |
| Determined for materials dried 2 | | | |
| hours at 105° C. | | | |
| pH of 4% dispersion | | 3.7-4.7 | 4.0-6.0 |
| SiO2 content | wt. % | ≦99.8 | ≦99.8 |
| in the annealed material | | | |

| | PMMA/A200 | | | PMMA/R711 | | |
|---|---|---|---|---|---|---|
| | | | Elongation | | | Elonga- |
| Silica | Young's | Tensile | at | Young's | Tensile | tion at |
| content | modulus | strength | break | modulus | strength | break |
| wt. % | (MPa) | (MPa) | (%) | (MPa) | (MPa) | (%) |
| 2 | 3.9 | 140.3 | 4.7 | 3.5 | 136.3 | 5.0 |
| 4 | 6.3 | 148.6 | 6.0 | 4.3 | 147.0 | 7.2 |
| 8 | 15.7 | 158.6 | 5.9 | 9.2 | 168.1 | 10.3 |
| 10 | 18.9 | 145.4 | 3.7 | 11.3 | 160.9 | 7.9 |
| 12 | 20.1 | 140 | 3 | 14.8 | 146.4 | 6.9 |

### Example 3

Polymeric nanocomposite based on PC (Makrolon) with a volume fraction of silica nanoparticles (silica—unmodified surface Sigma-Aldrich—specific surface area 390 m²/g, particle size 7 nm; silica coated with Cab-O-Sil TS-530—surface area 220 m²/g) 2, 4, 8 and 12 vol % was prepared utilizing the following procedure :

1) Thermoplastic granulate was dried at 90° C.

2) The granulate was then dissolved in various organic solvents (acetone, toluene, acetone/toluene 1:1, dichloromethane, methyl ethyl ketone).

3) Nanoparticles were vacuum-dried at 120° C. for 24 hours.

4) The nanoparticles were subsequently dispersed through sonication and stirred into the same solvent at 50° C. for 1 hour.

5) The mixture of nanoparticles and solvent were added to the dissolved granulate and stirred for 3 hours.

6) The organic solvent was removed through gradual drying at stirring by a mechanical stirrer. Subsequently the dried thermoplastic nanocomposite was crushed (drying at 140° C. for 2 hours, grinding, drying at 145 C for 3 hours, crushing, vacuum drying at 150 ° C. for 3 hours).

7) The dried thermoplastic nanocomposite was pressed at 240° C. into sheets 0.5 mm thick.

| | PC/A200 | | | PC/R711 | | |
|---|---|---|---|---|---|---|
| | | | Elongation | | | Elonga- |
| Silica | Young's | Tensile | at | Young's | Tensile | tion at |
| content | modulus | strength | break | modulus | strength | break |
| wt. % | (MPa) | (MPa) | (%) | (MPa) | (MPa) | (%) |
| 2 | 4.9 | 120.3 | 15.7 | 4.5 | 129.0 | 20.0 |
| 4 | 7.1 | 138.2 | 16.1 | 7.0 | 137.2 | 17.2 |
| 8 | 12.3 | 141.7 | 15.3 | 11.4 | 151.2 | 17.3 |
| 10 | 14.5 | 140.9 | 13.2 | 14.1 | 162.5 | 15.1 |
| 12 | 16.9 | 135.2 | 7.5 | 14.5 | 136.4 | 8.8 |

1. An abrasion resistant material, characterized in that it comprises a polymeric matrix composite, preferably selected from the group comprising amorphous thermoplastics and resins, containing homogenously dispersed nanoparticles ranging in size from 1 to 50 nm, further combined with clusters of the said nanoparticles, or a combination of nanoparticles of different sizes within the above stated range.

2. The material according to claim 1, wherein the polymeric matrix is amorphous thermoplastic, and nanoparticles having the size in the range of 1 to 50 nm are dispersed in a quantity of 0.1 to 15 vol. % relative to the volume of the amorphous thermoplastic.

3. The material according to claim 2, wherein the amorphous thermoplastic is selected from the group comprising polyesters such as polymethylmethacrylate, methacrylate and acrylate copolymers, polyethylene terephthalate, polycarbonate, amorphous polymers such as polystyrene.

4. The material according to claim 1, wherein the polymeric matrix is resin, and nanoparticles having the size in the range of 2 to 50 nm are preferably dispersed in a quantity of up to 6 vol. % relative to the volume of the resin.

5. The material according to claim 4, wherein the resin is selected from dimethacrylate, epoxy resin, polyurethane or polyurethane/acrylic resins that harden after application by chemical, thermal or radiation crosslinking, polymeric dispersions hardening by the evaporation of solvents, or fusible resin powders that are spread on a surface and then exposed to high temperatures to induce a process of melting and sintering into a compact layer.

6. The material according to claim 1, wherein the nanoparticles are selected from pyrolytic silica, colloidal silica, POSS particles, laponite, montmorrilonite, alumina, Al₂O₃ whiskers, cellulose whiskers and nanocrystals, ZrO₂ particles, graphene, C60, carbon nanotubes or a combination of the said particles.

7. The material according to claim 6, wherein surface of the nanoparticles is modified by an oligomer that is compatible with the polymeric matrix in which the nanoparticles are dispersed.

8. The material according to claim 1, wherein one group of nanoparticles are at least 2× larger, preferably 5× larger, than the other group of nanoparticles.

9. The material according to claim 1, wherein the nanoparticles are pyrolytic silica, preferably surface-modified by methacryl silane.

10. A method of preparation of the abrasion-resistant material, characterized in that monomers are mixed with nanoparticles and optionally other components, and the mixture is stirred for at least 1 hour and subsequently subjected to sonication for at least 0.5 hour.

11. The method according to claim 10, wherein a polyurethane acrylate monomer is mixed with a UV polymerization initiator and nanoparticles, and the mixture is stirred for at least 1 hour and subsequently subjected to sonication for at least 0.5 hour, whereas the UV polymerization initiator is preferably a mixture of camphoroquinone and 2-(N, N-dimethylamino)ethyl methacrylate in a quantity of up to 2 wt. % relative to the weight of the reaction mixture.

12. Automotive parts, characterized in that they are produced from the thermoplastic material according to claim 2, or contain at least one surface layer of the thermoplastic material according to claim 2.
